(19) United States
(12) Patent Application Publication
(10) Pub. No.: US 2002/0119283 A1
(43) Pub. Date: Aug. 29, 2002

(54) Sheath structure of bicycle grip

(76) Inventor: Kevin Si, Changhua Hsien (TW)

Correspondence Address: BACON & THOMAS, PLLC, 625 Slaters Lane, 4th Floor, Alexandria, VA, 22314-1176, US

(21) Appl. No.: 09/791,558

(22) Filed: Feb. 26, 2001

(51) Int. Cl. B32B 3/06

(52) U.S. Cl. 428/99

(57) ABSTRACT

Sheath structure of bicycle grip, including an outer sleeve, an inner tube, a bolt, a spring washer and a nut. The outer sleeve is cut with several transverse slots. The inner end of the outer sleeve is formed with a thinner snapping skirt section. The inner tube has an inner diameter slightly larger than the outer diameter of the grip. The outer end of the inner tube is formed with an annular binding rib. The binding rib and an outer end section of the inner tube are cut with a resilient split. The binding rib is formed with two projecting locking blocks on two sides of the resilient split. Each locking block is formed with a stepped embedding hole. A middle portion of the outer circumference of the inner tube is formed with a convex face corresponding to the curvature of a palm. The inner tube is formed with an annular snapping rib near the inner end thereof with larger diameter. The inner end of the inner tube is formed with an annular stop rib with even larger diameter.

### BACKGROUND OF THE INVENTION

The present invention is related to an improved sheath structure of bicycle grip. The inner diameter of the inner tube is slightly larger than the outer diameter of the grip so that the inner tube can be easily fitted onto the grip. A bolt is passed through the embedding hole of the inner tube to be screwed with a nut so as to achieve a better tightening force. A spring washer is disposed between the bolt and the nut to prevent the bolt from loosening. The holding portion of the sheath has a convex face corresponding to the curvature of the palm so that a user can tightly hold the grip without slippage. The sheath is air-permeable so that the user will feel comfortable when holding the sheath.

FIGS. 1 and 2 show a conventional grip sheath structure of a bicycle. The grip sheath has an inner tube 11 made of harder material such as plastic material. The inner tube 11 has an inner diameter slightly smaller than the outer diameter of the grip 10. The outer end of the inner tube 11 is cut with an axial split 111. The outer circumference of the inner tube 11 is formed with several annularly arraged locating holes 112. In addition, the outer end of the inner tube 11 is formed with a flange 113 having a thread hole 114 in which a bolt 13 is screwed and tightened. The grip sheath further includes an outer sleeve 12 made of softer material such as rubber. The outer sleeve 12 is fitted around the inner tube 11 and integrally connected therewith. The inner circumference of the outer sleeve 12 is formed with several locating projections 121 corresponding to the locating holes 112 of the inner tube 11. When fitting the grip sheath onto the grip 10 of the bicycle, the outer sleeve 12 is first fitted around the inner tube 11 with the locating projections 121 inserted in the locating holes 112 of the inner tube 11. Then, a pressing force is applied to the inner tube 11 to tightly fit the inner tube 11 onto the grip 10. Finally, the bolt 13 is screwed and tightened in the thread hole 114 of the inner tube 11 to shut the split 111. Under such circumstance, the inner tube 11 is bound on the grip 10.

The above structure has some shortcomings as follows:

1. The inner diameter of the inner tube 11 is slightly smaller than the outer diameter of the grip 10. Accordingly, it is hard to fit the inner tube 11 onto the grip 10.

2. The inner tube 11 is forcedly pressed to fit onto the grip 10. In the case that the pressing force is not directed right to the inner tube 11 and is deflected, the inner tube 11 can be hardly tightly fitted on the grip 10. As a result, when riding the bicycle, the sheath will loosen and swing.

3. The inner tube 11 is made of plastic material, while the bolt 13 is metal-made and directly screwed in the thread hole 114 of the inner tube 11. In the case of over-tightening, the thread of the thread hole 114 may be broken.

4. The bolt 13 is directly screwed in the thread hole 114 of the inner tube 11 and no spring washer is disposed therebetween for preventing the bolt 13 from loosening. Therefore, due to shock in riding, the bolt 13 may loosen and the sheath may detach from the grip 10.

5. The outer circumference of the outer sleeve 12 has a straight face without curvature in accordance with the palm. Therefore, when holding the sheath, the outer sleeve 12 can hardly snugly attach to the palm of the user so that the user can hardly tightly hold the grip and may slip away from the grip. In addition, the outer sleeve 12 is impermeable so that the user will feel uncomfortable when holding the sheath.

### SUMMARY OF THE INVENTION

It is therefore a primary object of the present invention to provide an improved sheath structure of bicycle grip in which the inner diameter of the inner tube is slightly larger than the outer diameter of the grip. Accordingly, it is easy and quick to fit the inner tube onto the grip.

It is a further object of the present invention to provide the above sheath structure in which the inner tube can be fitted onto the grip without applying any pressing force onto the inner tube. Therefore, the inner tube will not be deflected and the inner tube can be entirely tightly fitted on the grip. As a result, when riding the bicycle, the sheath will not loosen or swing.

The present invention can be best understood through the following description and accompanying drawings wherein:

### BRIEF DESCRIPTION OF THE DRAWINGS

FIG. 1 is a longitudinal sectional view of a conventional sheath structure of bicycle grip;

FIG. 2 is a cross-sectional view of the conventional sheath structure of bicycle grip in a locked state;

FIG. 3 is a perspective exploded view of the sheath structure of the present invention;

FIG. 4 is a perspective assembled view of the sheath structure of the present invention;

FIG. 5 is a longitudinal sectional assembled view of the sheath structure of the present invention; and

FIG. 6 is a sectional view of the sheath structure of the present invention, showing the locked section thereof.

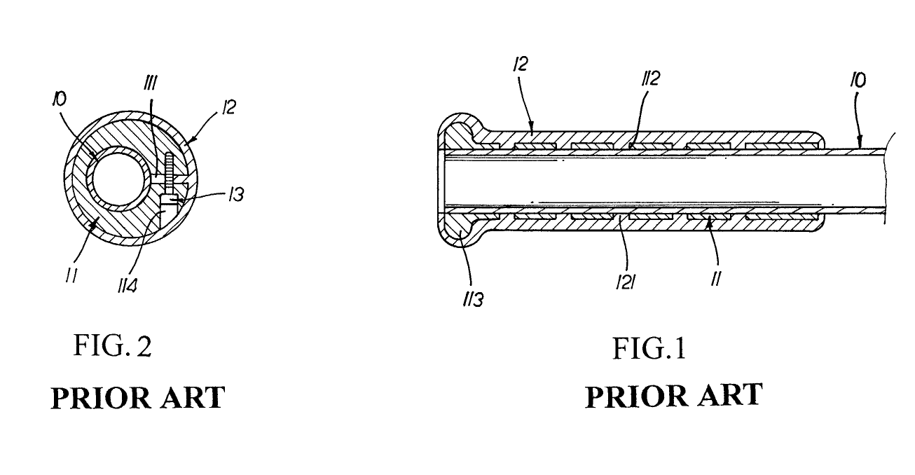

### DETAILED DESCRIPTION OF THE PREFERRED EMBODIMENT

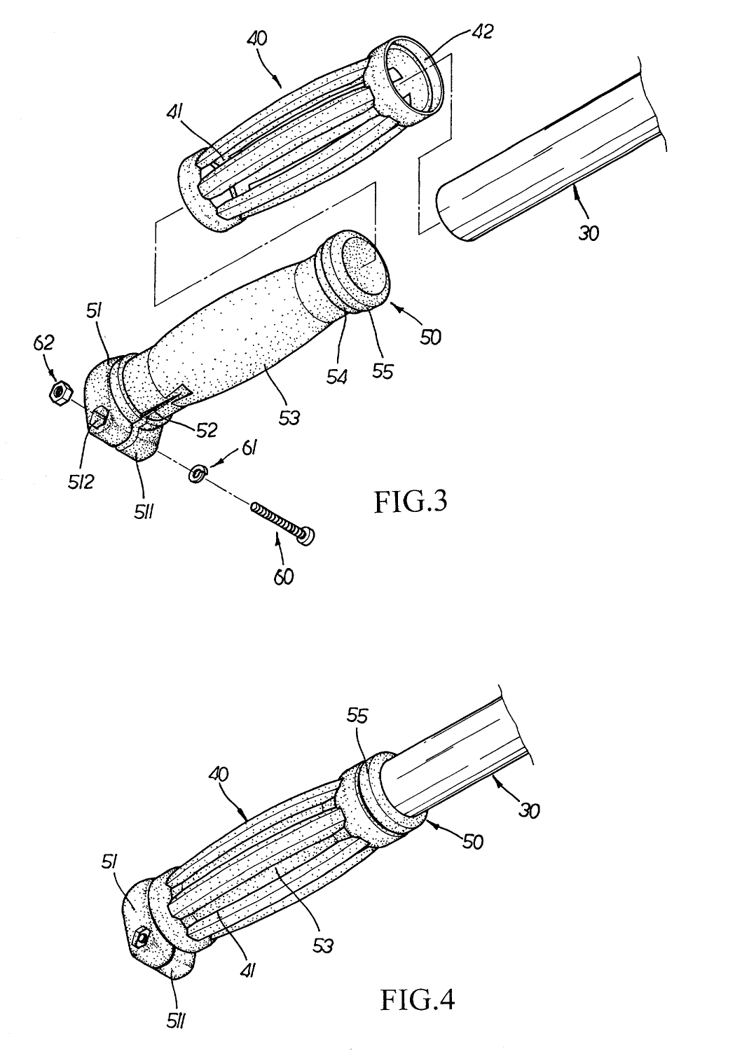

Please refer to FIG. 3. The sheath structure of bicycle grip of the present invention includes an outer sleeve 40, an inner tube 50, a bolt 60, a spring washer 61 and a nut 62. The outer sleeve 40 is made of softer material such as rubber and cut with several transverse slots 41 at equal intervals. The inner end of the outer sleeve 40 is formed with a thinner snapping skirt section 42. The inner tube 50 is made of harder material such as plastic material. The inner tube 50 has an inner diameter slightly larger than the outer diameter of the grip 30. The outer end of the inner tube 50 is formed with an annular binding rib 51 with larger diameter. The binding rib 51 and an outer end section of the inner tube 50 are cut with a V-shaped resilient split 52 with wider outer end and narrower inner end. The binding rib 51 is further formed with two projecting locking blocks 511 on two sides of the resilient split 52. Each locking block 511 is formed with a stepped embedding hole 512 with larger outer section and smaller inner section. The large diameter section of the embedding hole 512 is hexagonal. The middle portion of the outer circumference of the inner tube 50 is formed with a convex face 53 corresponding to the curvature of the palm. The inner tube 50 is formed with an annular snapping rib 54 near the inner end thereof. The snapping rib 54 has a larger diameter. The inner end of the inner tube 50 is formed with an annular stop rib 55 with even larger diameter.

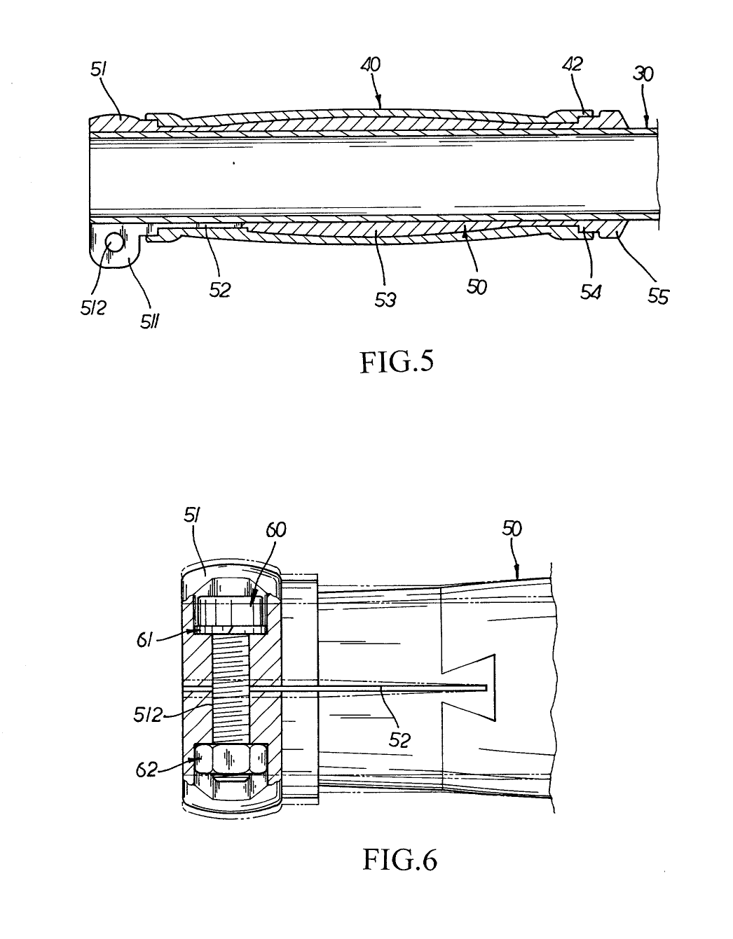

When assembled, as shown in FIGS. 4, 5 and 6, the outer sleeve 40 is first fitted around the inner tube 50 and tightly attached to the convex face 53 thereof. The snapping skirt section 42 is firmly fitted on the snapping rib 54 of the inner tube 50 and snaps the same. At this time, the outer sleeve 40 is stopped by the stop rib 55 of the inner tube 50 and firmly associated with the inner tube 50. Then, the inner tube 50 with the outer sleeve 40 is fitted onto the end of the grip 30. The inner tube 50 has an inner diameter slightly larger than the outer diameter of the grip 30 so that the inner tube 50 can be easily fitted onto the grip 30 without deflection. Thereafter, the spring washer 61 is fitted around the bolt 60 which is then passed through the embedding hole 512 of the inner tube 50 to extend out of the other side of the embedding hole 512 by a certain length. At this time, the nut 62 is screwed onto the bolt 60 to tighten the same. Under such circumstance, the two locking blocks 511 of the inner tube 50 are forced toward each other and locked together. Simultaneously, the resilient split 52 is shut and the inner tube 50 is bound on the grip 30. The resilient split 52 is V-shaped so as to enlarge the binding area. Accordingly, the inner tube 50 can be truly bound on the end of the grip 30.

According to the above arrangement, the present invention has the following advantages:

1. The inner diameter of the inner tube 50 is slightly larger than the outer diameter of the grip 30. Accordingly, it is easy and quick to fit the inner tube 50 onto the grip 30.

2. The inner tube 50 can be fitted onto the grip 30 without applying any pressing force onto the inner tube 50. Therefore, the inner tube 50 will not be deflected and the inner tube 50 can be entirely tightly fitted on the grip 30. As a result, when riding the bicycle, the sheath will not loosen or swing.

3. The bolt 60 is passed through the embedding hole 512 of the inner tube 50 to be screwed with the nut 62. The materials of the bolt 60 and the nut 62 are the same so that the a better tightening force is achieved and the thread will not be broken.

4. A spring washer 61 is disposed between the bolt 60 and the nut 62 to prevent the bolt 61 from loosening. Therefore, the bolt 60 will not loosen due to shock in riding,

5. The sheath structure has simplified components so that the cost for material is lowered and the components can be more easily and quickly assembled.

6. The resilient split 52 is V-shaped and extends to the convex face 53 of the inner tube 50 by a certain length so that the binding area is enlarged. Accordingly, the inner tube 50 can be more truly bound on the end of the grip 30.

7. The holding portion of the inner tube 50 is formed with a convex face 53 corresponding to the curvature of the palm and the outer sleeve 40 is snugly tightly attached to the convex face 53. Therefore, when holding the sheath, the outer sleeve 40 can entirely snugly attach to the palm of the user so that the user can tightly hold the grip without slippage. In addition, the outer sleeve 40 is formed with several slots 41 for ventilation so that the sheath is permeable and the user will feel comfortable when holding the sheath.

The above embodiment is only used to illustrate the present invention, not intended to limit the scope thereof. Many modifications of the above embodiment can be made without departing from the spirit of the present invention.

What is claimed is:

1. Sheath structure of bicycle grip, comprising an outer sleeve, an inner tube, a bolt, a spring washer and a nut, the outer sleeve being made of softer material such as rubber, the inner tube being made of harder material such as plastic material, said sheath structure being characterized in that:
the outer sleeve is cut with several transverse slots at equal intervals, an inner end of the outer sleeve being formed with a thinner snapping skirt section; and
the inner tube has an inner diameter slightly larger than the outer diameter of the grip, an outer end of the inner tube being formed with an annular binding rib with larger diameter, the binding rib and an outer end section of the inner tube being cut with a resilient split, the binding rib being further formed with two projecting locking blocks on two sides of the resilient split, each locking block being formed with a stepped embedding hole, a middle portion of the outer circumference of the inner tube being formed with a convex face corresponding to the curvature of a palm, the inner tube being formed with an annular snapping rib near the inner end thereof, the snapping rib having a larger diameter, the inner end of the inner tube being formed with an annular stop rib with even larger diameter, whereby the outer sleeve is fitted around the inner tube with the snapping skirt section firmly fitted on the snapping rib of the inner tube and snapping the same, the outer sleeve being stopped by the stop rib of the inner tube, the inner tube with the outer sleeve being fitted onto an end of the grip, the spring washer being fitted around the bolt which is then passed through the embedding hole of the inner tube to be screwed with the nut.

2. Sheath structure as claimed in claim 1, wherein the resilient split is V-shaped with wider outer end and narrower inner end, whereby the inner tube is bound on the grip by an enlarged binding area.
